(19) United States
(12) Patent Application Publication
(10) Pub. No.: US 2025/0218171 A1
(43) Pub. Date: Jul. 3, 2025

(54) RECOGNITION SYSTEM AND RECOGNITION METHOD FOR INTERACTIVE INDICATOR

(71) Applicant: INDUSTRIAL TECHNOLOGY RESEARCH INSTITUTE, Hsinchu (TW)

(72) Inventors: Pi-Hsien WANG, Hsinchu City (TW); Yu-Hsin LIN, Toufen City (TW); Chih-Chia CHANG, Zhubei City (TW)

(73) Assignee: INDUSTRIAL TECHNOLOGY RESEARCH INSTITUTE, Hsinchu (TW)

(21) Appl. No.: 18/664,976

(22) Filed: May 15, 2024

(30) Foreign Application Priority Data
Dec. 29, 2023 (TW) 112151596

(51) Int. Cl. G06V 10/70; G06V 10/56; G06V 10/60; G06V 10/776; G06V 10/98; G06V 20/40; G06V 40/16; G06V 40/20

(52) U.S. Cl. CPC G06V 10/87; G06V 10/56; G06V 10/60; G06V 10/776; G06V 10/993; G06V 20/46; G06V 40/168; G06V 40/20

(57) ABSTRACT

A recognition system and a recognition method for an interactive indicator are provided. The recognition method for the interaction indicator includes the following steps. At least one recognition method is used to recognize the interaction indicator. The recognition method is not exactly the same at different times. When the interaction indicator is recognized and a recognition confidence of the interaction indicator is higher than a predetermined level, a weight value of the recognition method is increased.

This application claims the benefit of Taiwan application Serial No. 112151596, filed Dec. 29, 2023, the disclosure of which is incorporated by reference herein.

### TECHNICAL FIELD

The disclosure relates to a recognition system and a recognition method for interactive indicator.

### BACKGROUND

With the advancement of image recognition technology, objects or object postures could be recognized. The system could respond to this object or object posture. It could be called “interactive” and this object or this object posture could be used as an interaction indicator. For example, users could use gestures, body postures, or facial orientation to indicate various interaction indicators in various fields. The interaction indicator, after recognition, could be used to activate the corresponding interactive method, such as displaying the corresponding frame. Alternatively, the traffic vehicle is equipped with sensors to recognize the road indication or the obstacle and use these recognition results as an interaction indicator to give feedback on the direction in which the traffic vehicle should stop or proceed.

However, changes in fields are quite complex. How to adapt to changes in various fields without disturbing the recognition of the interaction indicators is a difficult challenge. What needs to be overcome is the color interference of ambient light and/or the confusion of multiple objects that obscures the interaction indicator. For example, the ambient light in some exhibition venues is dim, and the user's posture, facial features or hand gestures may easily be misjudged. Alternatively, the user's posture, hand gestures and hand joint nodes may be obscured by the body or clothing, which may easily lead to misjudgment. Or, when the car is driving and the vision is backlit, it will be difficult to see the road ahead clearly. In order to overcome various situations, the researchers are working on developing a recognition method for the interaction indicator that is suitable for various scenarios.

### SUMMARY

The disclosure is directed to a recognition system and a recognition method for an interactive indicator.

According to one embodiment, a recognition method for an interaction indicator is provided. The recognition method for the interaction indicator is used for recognizing the interaction indicator in a video. The recognition method for the interaction indicator includes: recognizing the interaction indicator via at least one recognition method, wherein the recognition method is not exactly the same at different times; and increasing a weight value of the recognition method, when the interaction indicator is recognized and a recognition confidence of the interaction indicator is higher than a predetermined level.

According to another embodiment, a recognition system for an interaction indicator is provided. The recognition system for the interaction indicator is used for recognizing the interaction indicator in a video. The recognition system for the interaction indicator includes a recognition unit, a weight setting unit and a storage unit. The recognition unit is used for recognizing the interaction indicator via a recognition method. The recognition method is not exactly the same at different times. The weight setting unit is used for summarizing a weight value of the recognition method, when the interaction indicator is recognized and a recognition confidence of the interaction indicator is higher than a predetermined level. The storage unit is used for storing a recognition result, the weight value of the recognition method, the interaction indicator and the recognition confidence.

### BRIEF DESCRIPTION OF THE DRAWINGS

FIG. 1 illustrates a schematic diagram of a scene according to an embodiment of the present disclosure.

FIG. 2 illustrates a schematic diagram of a scene according to an embodiment of the present disclosure.

FIG. 3 illustrates a schematic diagram of a scene according to an embodiment of the present disclosure.

FIG. 4 illustrates a schematic diagram of a scene according to an embodiment of the present disclosure.

FIG. 5 illustrates a recognition system for an interaction indicator according to one embodiment of the present disclosure.

FIG. 6 illustrates a flow chart of a recognition method for an interaction indicator according to an embodiment of the present disclosure.

FIGS. 7A to 7B illustrate a flow chart of a recognition method for an interaction indicator according to an embodiment of the present disclosure.

FIG. 8 illustrates a recognition system for an interaction indicator according to one embodiment of the present disclosure.

FIG. 9 illustrates a flow chart of a recognition method for an interaction indicator according to an embodiment of the present disclosure.

FIG. 10 illustrates a recognition system for an interaction indicator according to one embodiment of the present disclosure.

FIG. 11 illustrates a flow chart of a recognition method for an interaction indicator according to an embodiment of the present disclosure.

FIG. 12 illustrates a recognition system for an interaction indicator according to one embodiment of the present disclosure.

FIG. 13 illustrates a flow chart of a recognition method for an interaction indicator according to an embodiment of the present disclosure.

FIG. 14 illustrates a recognition system for an interaction indicator according to one embodiment of the present disclosure.

FIG. 15 illustrates a flow chart of a recognition method for an interaction indicator according to an embodiment of the present disclosure.

FIGS. 16A to 16B illustrate an application example of a recognition method for an interaction indicator according to an embodiment of the present disclosure.

FIGS. 17A to 17B illustrate another application example of the recognition method for the interaction indicator disclosed in the present disclosure.

FIGS. 18A to 18B illustrate another application example of the recognition method for the interaction indicator disclosed in the present disclosure.

FIG. 19 illustrates another application example of the recognition method for the interaction indicator disclosed in the present disclosure.

FIG. 20 illustrates another application example of the recognition method for the interaction indicator disclosed in the present disclosure.

FIG. 21 illustrates another application example of the recognition method for the interaction indicator disclosed in the present disclosure.

FIG. 22 illustrates another application example of the recognition method for the interaction indicator disclosed in the present disclosure.

In the following detailed description, for purposes of explanation, numerous details are set forth in order to provide a thorough understanding of the disclosed embodiments. It will be apparent, however, that one or more embodiments may be practiced without these details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

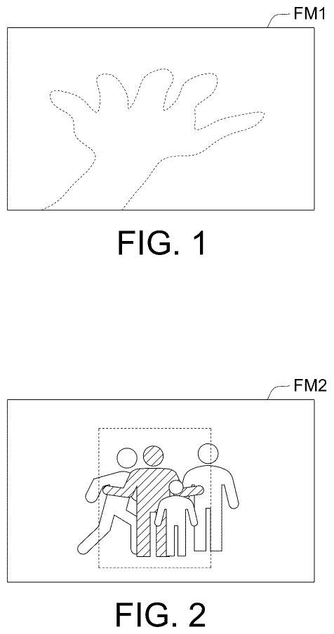

Please refer to FIG. 1, which illustrates a schematic diagram of a scene according to an embodiment of the present disclosure. When the user uses gestures to manipulate the frame towards the screen or camera, the background may have a similar color to the hand or object used as the interaction indicator or may interfere with the sunlight shadow in the video. When recognizing the interaction indicator, a frame FM1 may be interfered by ambient light or color, making the interaction indicator to be recognized unclear.

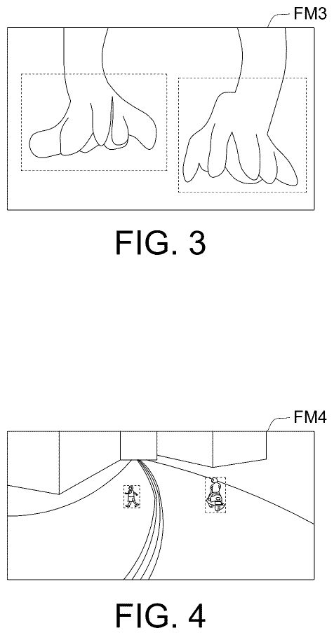

Please refer to FIG. 2, which illustrates a schematic diagram of a scene according to an embodiment of the present disclosure. When recognizing the interaction indicator, the gesture or object used as the interaction indicator in a frame FM2 may be obscured and interfered, and the interaction indicator cannot be correctly recognized.

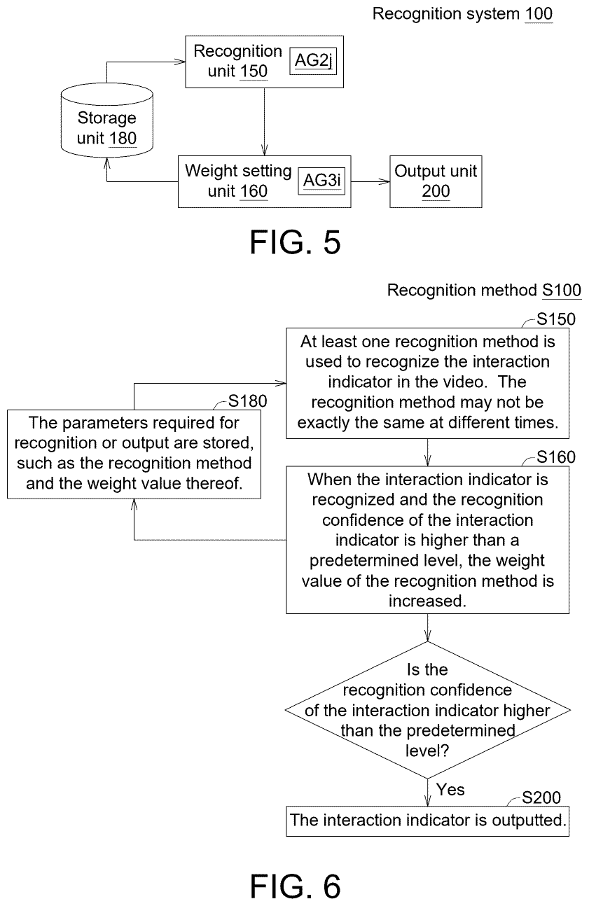

Please refer to FIG. 3, which illustrates a schematic diagram of a scene according to an embodiment of the present disclosure. When recognizing the interaction indicator, the gesture or object in a frame FM3 may have insufficient hand joint nodes features or other detailed features due to the angle, and the interaction indicator cannot be correctly recognized.

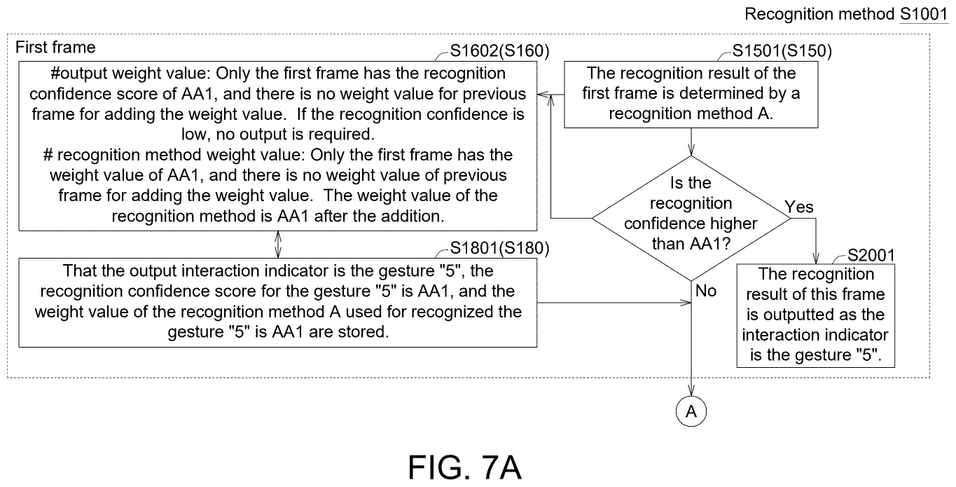

Please refer to FIG. 4, which illustrates a schematic diagram of a scene according to an embodiment of the present disclosure. A sensor (for example, a camera) in front of the vehicle senses the road conditions in front of the vehicle to warn the vehicle of stopping or traveling direction. When recognizing interaction indicators (such as obstacles), a frame FM4 may obscure features due to clothing or orientation, or interfere with the video in the dark or overexposed sunlight, causing the interaction indicator object to be recognized to become unclear.

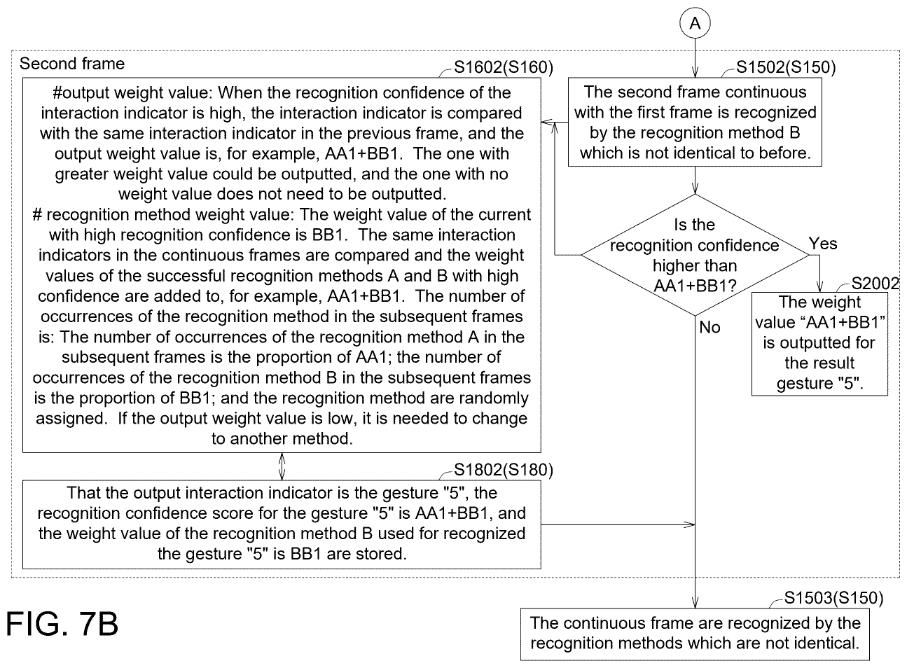

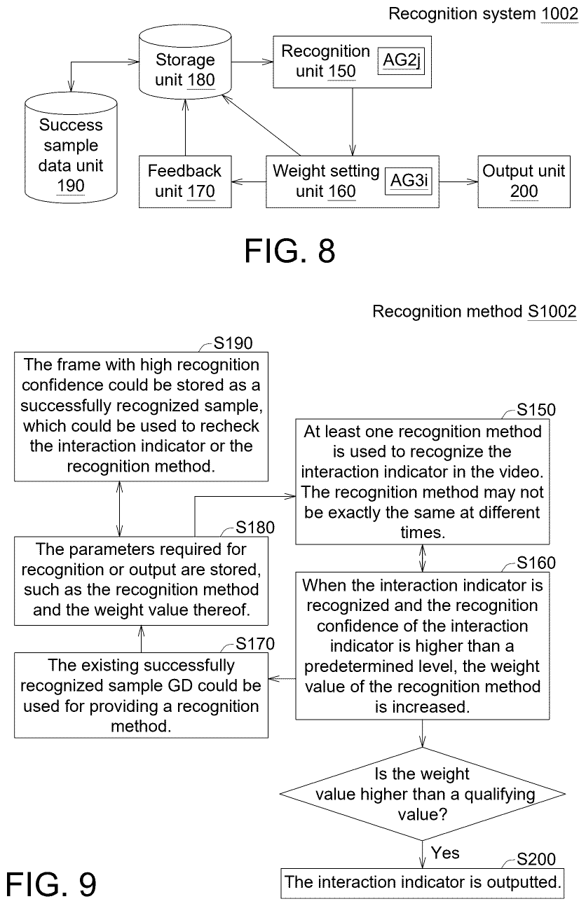

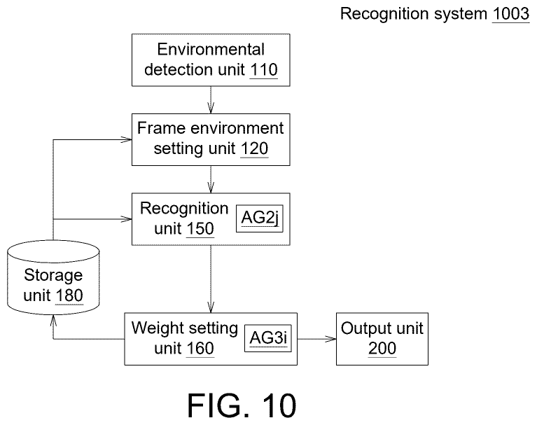

Please refer to FIG. 5, FIG. 6, and FIGS. 7A to 7B. The FIG. 5 illustrates a recognition system 100 for an interaction indicator IX according to one embodiment of the present disclosure. The recognition system 100 includes a recognition unit 150, a weight setting unit 160, a storage unit 180, and an output unit 200.

FIG. 6 illustrates a flow chart of recognition method S100 for the interaction indicator IX according to an embodiment of the present disclosure. The recognition method S100 for the interaction indicator IX may include steps S150 to S200. In the step S150, at least one recognition method AG2j is used to recognize the interaction indicator IX in the video VD. The recognition method AG2j may not be exactly the same at different times. In the step S160, when the interaction indicator IX is recognized and the recognition confidence of the interaction indicator IX is higher than a predetermined level, the weight value of the recognition method AG2j is increased. In the step S180, the parameters required for recognition or output are stored, such as the recognition method and the weight value thereof. In the step S200, if the recognition confidence of the interaction indicator IX is higher than the predetermined level, the interaction indicator could be outputted. The interaction indicator IX could be gestures, body postures, facial features in the frame, or road conditions or obstacles that affect the stopping or traveling direction of the vehicle. Steps S1501, S1502, S1503, S1601, S1602, S1801, S1802, 2001, 2002 are detailed steps, and the detailed explanation is illustrated as follows.

FIGS. 7A to 7B illustrate a flow chart of a recognition method S1001 for the interaction indicator IX according to an embodiment of the present disclosure. For example, the interaction indicator IX is a gesture as an example. The gesture is number 0 to 9. In reality, to verify the gesture “5” of the interaction indicator, the user will stretch out 5 fingers. In order to recognize the correct interaction indicator IX which is the gesture “5”, this disclosure could use the recognition unit 150 to recognize the interaction indicator IX via different recognition methods AG2j in different times. According to the requirements, a predetermined level is defined. a recognition result having a recognition confidence higher than the predetermined level is acceptable. For example, for a yolo object recognition method, the predetermined level (confidence score) for the recognition confidence is defined as 80%. Or the predetermined level for the recognition confidence could be customized to be stricter or looser according to the usage requirements. For example, gestures used in precision medical operations may require strictly correct output; while operations used in children's games may focus more on high-frequency output. Next, the weight setting unit 160 evaluates the output results via a weight calculation method AG3i. The following operation is used to illustrate continuous interaction indicator actions in continuous frames. In the step S1501, the recognition result of the first frame determined by a recognition method A is that the interaction indicator is gesture “5” and the recognition confidence is AA1. In the step S1601, since there is no previous recognition record within a continuous time for the same interaction indicator, the recognition confidence of the recognition method A is AA1, and the weight value is not increased due to no previous frame. In the step S1801, the storage unit 180 stores that the output interaction indicator is the gesture “5”, the recognition confidence score for the gesture “5” is AA1, and the weight value of the recognition method A used for recognized the gesture “5” is AA1, which is related to the recognition confidence. In the step S2001, the recognition result of this frame is outputted as the interaction indicator is the gesture “5”. In the step S1502, the second frame continuous with the first frame is recognized via a different recognition method. In the step S1602, before the gesture is outputted, the weight setting unit 160 compares the weight value of the same gesture “5” with the previous frame. The weight value is outputted as follows. The interaction indicator of the recognition method B used in this frame is the gesture “5”, and the recognition confidence is BB1. The same interaction indicator of the gesture “5” is recognized in the previous frame, the weight value of the gesture “5” will be increased to be the sum of the weight values for the same interaction indicator within the continuous time, such as AA1+BB1. The weight value of the recognition method A and B will be increased to AA1+BB1. This weight value is used as the parameter for selecting the recognition method for subsequent continuous time and for determining the output result (step S1802). In the next frame, the interaction indicator of a recognition method C is the gesture “5”, and the recognition confidence is reduced to CC1, so the weight value of the recognition method C is not increased. The interaction indicators in the previous frame and the subsequent frame are the output of the gesture “5”. The weight value “AA1+BB1” could be outputted for the result gesture “5” (step S2002). If the recognition result of a recognition method E for the next frame is that the interaction indicator is gesture “4”, and the recognition confidence is reduced to EE1, the weight value will not be outputted, and the weight value of the recognition method E will not be increased. Since there is no interaction result in the previous frame as the result of gesture “4”, this interaction result will not be outputted. The recognition result of a recognition method D for the next frame is that the interaction result is the gesture “4”, the recognition confidence is increased to DD1, and the output weight value is DD1. Since there is no previous frame that could be used to increase the weight value, the weight value DD1 for the current frame is used and the gesture “4” is outputted. As a result, if the result of the recognition method is incorrect, it is not easy to accumulate weight value under other recognition methods, which could reduce erroneous output results. In addition, after comparing the frames of a continuous action, the data of the frames for the continuous action may be cleared.

In one embodiment, the weight value of the recognition method is operated as follows. The continuous frames may be recognized via different recognition methods A, B, C, D, E, and the weight values of the recognition methods are AA1, BB1, CC1, DD1, EE1 respectively. If the weight values for the recognition methods are AA1>BB1>CC1>DD1>EE1, the number of occurrences of the recognition method A in the subsequent frames could be set according to the proportion of AA1, the number of occurrences of the recognition method B in the subsequent frames could be set according to the proportion of BB1, and so on. In this way, under multiple accumulations, methods with too low weight value will be diluted by other methods with high weight value. When the recognition method A is used for the second time and the recognition confidence is increased to AA2, the weight value obtained by the recognition method A could also be increased to AA1+AA2. If the recognition method A is used for the third time and the recognition confidence is reduced to AA3, the weight value will not be added, and the next frame with low recognition confidence could be given priority to other methods with the next highest weight value.

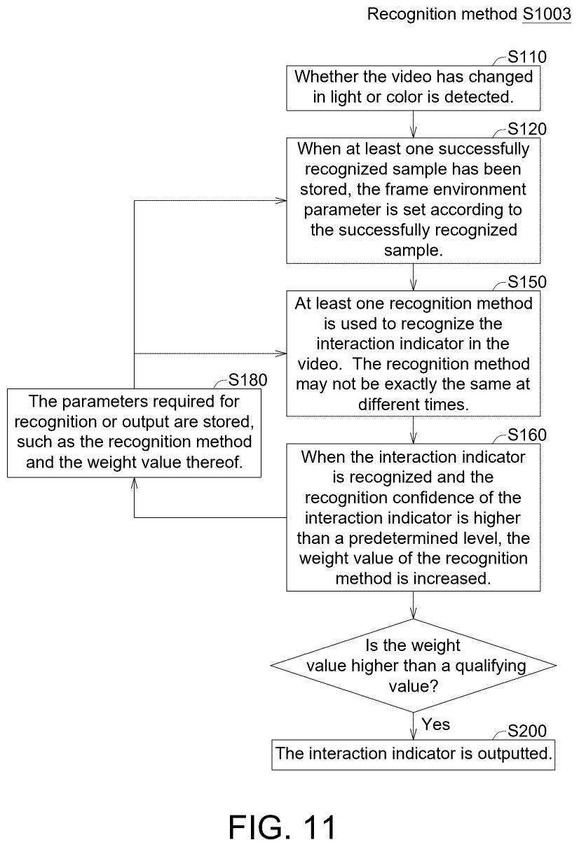

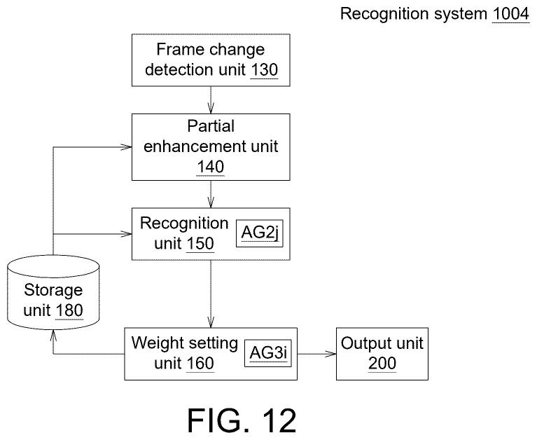

Please refer to FIG. 8 and FIG. 9. Another embodiment is that the recognition system 100 is expanded to a recognition system 1002. In addition to storing the weight value used by the subsequent weight calculation method in the weight setting unit 160, the storage unit 180 could also store the successfully recognized sample GD from the feedback unit 170 and the information of the successfully recognized sample from the successful sample data unit 190, such as frame with high recognition confidence and the related settings thereof.

Steps S150, S160, S180, S200 could be similar to the illustrations in the FIG. 6, and the similarities are not repeated here. In the step S170, the existing successfully recognized sample GD is used for selecting a recognition method. In the step S190, the frame with high recognition confidence could be stored as a successfully recognized sample, which could be used to recheck the interaction indicator IX or the recognition method AG2j.

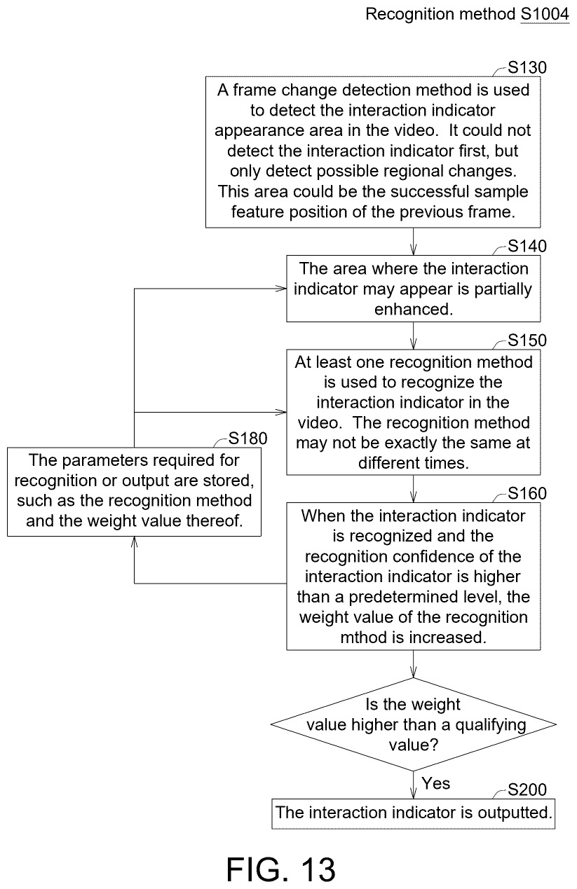

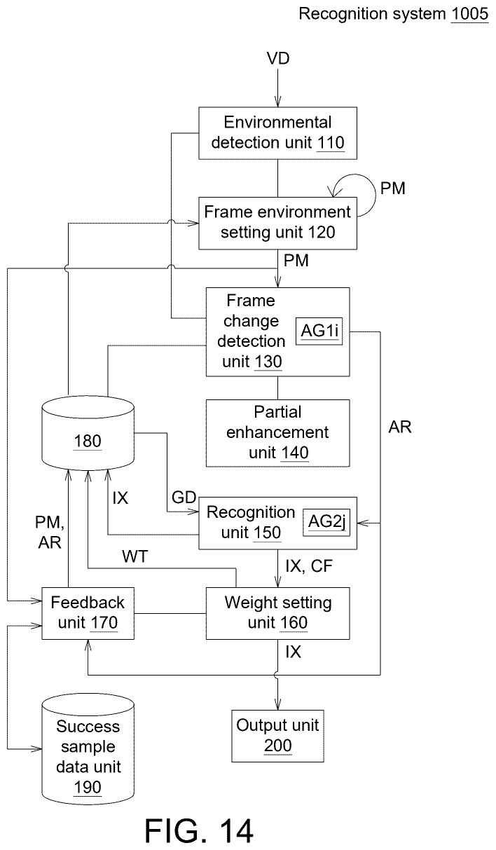

Please refer to FIG. 10 and FIG. 11. Another embodiment is that the recognition system 100 is expanded to a recognition system 1003. Before using the recognition unit 150, the environmental detection unit 110 and the frame environment setting unit 120 are used to adjust the frame environment to avoid light or color interference. a recognition method S1003 for the interaction indicator IX in the video VD includes steps S110, S120, S150, S160, S180, S200. The steps S150, S160, S180, and S200 could be similar to the description in FIG. 6, and will not be repeated here. In the step S110, whether the video VD has changed in light or color is detected. If so, the process proceeds to the step S120. In the step S120, when at least one successfully recognized sample has been stored, the frame environment parameter PM is set according to the successfully recognized sample.

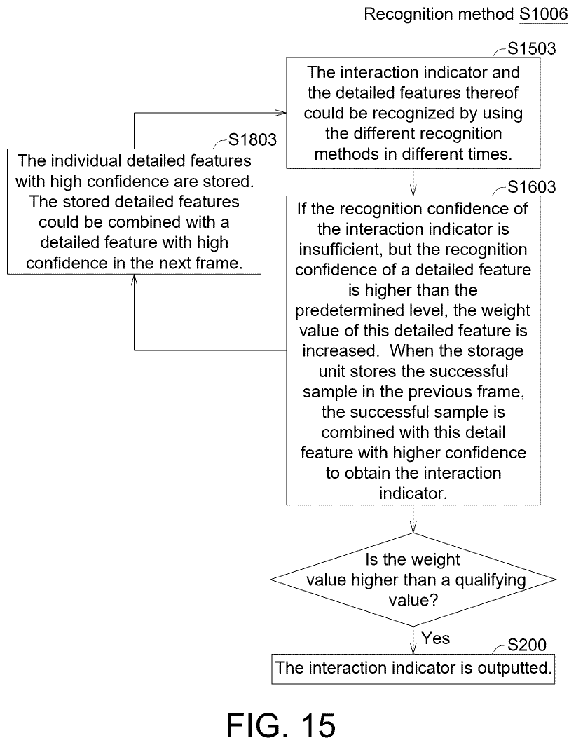

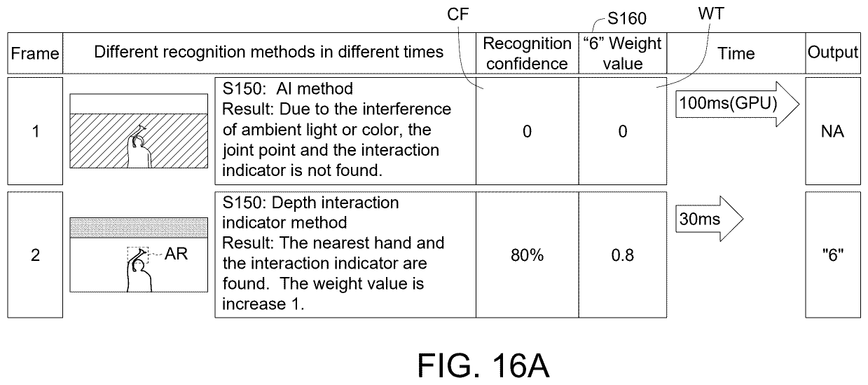

Please refer to FIG. 12 and FIG. 13. Another embodiment is that the recognition system 100 is expanded to a recognition system 1004. Before using the recognition unit 150, the frame change detection unit 130 could be used to detect the interaction indicator appearance area AR. For example, the interaction indicator may be located around the user's body, arms or palms, etc. If necessary, the interaction indicator appearance area AR could be strengthened by a partial enhancement unit 140. Then, the recognition unit 150 is used to recognize the interaction indicator IX in the interaction indicator appearance area AR using different recognition methods AG2j in different times, so as to quickly recognize the interaction indicator IX in order to adapt to different scenarios. The recognition method S1004 for the interaction indicator IX in the video VD includes steps S130, S140, S150, S160, S180, S200. The steps S150, S160, S180, and S200 could be similar to the description in FIG. 6, and will not be repeated here. In the step S130, a frame change detection method is used to detect the interaction indicator appearance area AR in the video VD. It could not detect the interaction indicator IX first, but only detect possible regional changes. This area could be successfully recognized sample of the previous frame. The process could optionally proceed to the step S140 to partially strengthen the area where the interaction indicator IX may appear.

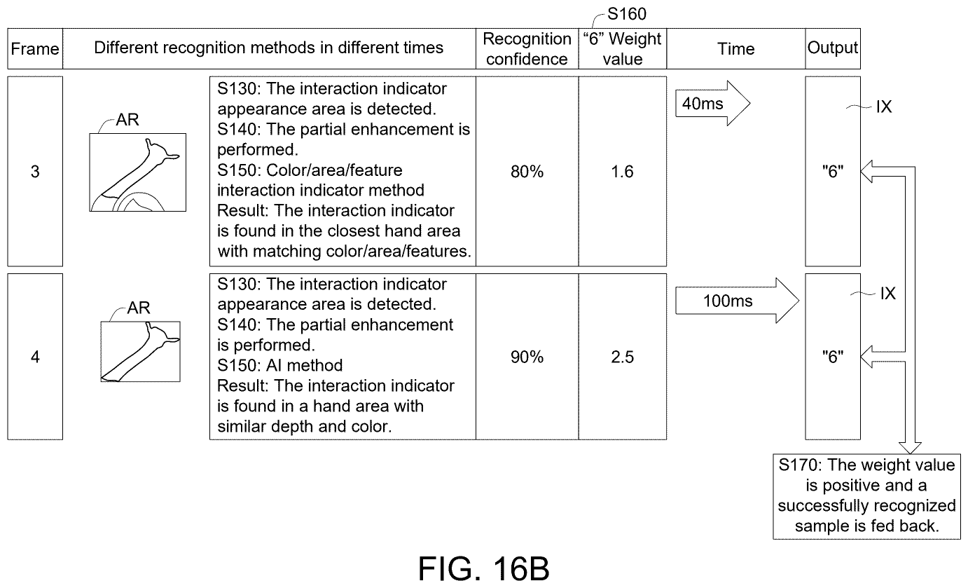

Please refer to FIG. 14. Another embodiment is that the recognition system 100 is expanded into a recognition system 1005. In addition to the environmental detection unit 110 and the frame environment setting unit 120 in FIGS. 10 and 11, the recognition system 1005 could also add the frame change detection unit 130 and the partial enhancement unit 140 in the FIGS. 12 and 13, and the feedback unit 170 in the FIGS. 8 and 9. The environmental detection unit 110 and the frame environment setting unit 120 are used to adjust the frame environment. The frame change detection unit 130 is used to detect the interaction indicator appearance area AR. The partial enhancement unit 140 is used to reinforce the interaction indicator appearance area AR. For the continuous frames, the feedback unit 170 could feed back information to the frame environment setting unit 120, the frame change detection unit 130, and the recognition unit 150 to strengthen the aforementioned settings and supplement the on-site environment collection to improve recognition confidence. All methods in the recognition system 1005 for the video VD could be manually selected or selected by the weight setting unit 160 to filter out the methods to be used after accumulating recognition results.

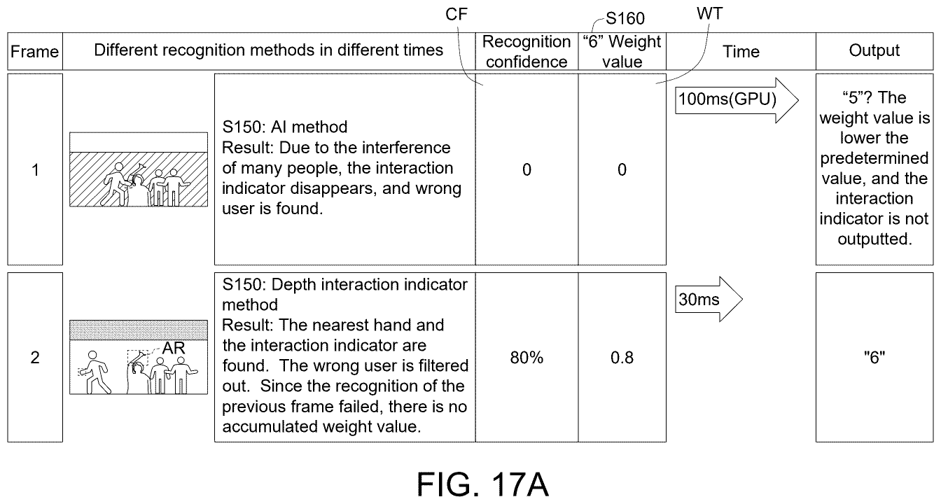

FIG. 15 illustrates a flow chart of the recognition method S1006 for the interaction indicator IX according to an embodiment of the present disclosure. The recognition method S1006 for the interaction indicator IX in the video VD includes steps S1503, S1603, S1803, and S200. In the step S1503, the interaction indicator IX and the detailed features thereof could be recognized by using the different recognition methods AG2j in different times. In the step S1603, if the recognition confidence of the interaction indicator is insufficient, but the recognition confidence of a detailed feature is higher than the predetermined level, the weight value of this detailed feature is increased. When the storage unit 180 stores the successfully recognized sample in the previous frame, the successfully recognized sample is combined with this detail feature with higher confidence to obtain the interaction indicator. In the step S1803, the individual detailed features with high confidence are stored. The stored detailed features could be combined with a detailed feature with high confidence in the next frame. The recognition method S1006 for the interaction indicator IX in the video VD includes steps S1503, S1603, S1803, and S200.

Taking the above-mentioned functions in FIGS. 5 to 15 as an example, the above-mentioned environmental detection unit 110 is used to detect whether the video VD changes in light or color. If the video VD has changed in light or color, the frame environment setting unit 120 could be used; if the video VD does not change in light or color, the frame environment setting unit 120 could be skipped and the frame change detection unit 130 is directly used. Generally, the frame environment setting unit 120 could be used as needed for dynamic scenes; the frame environment setting unit 120 is not necessary to use for static scenes.

Once it is found that the video VD has changed in light or color, at least one frame environment parameter PM will be set by the frame environment setting unit 120 to avoid interference from ambient light or color.

The frame environment parameter PM settings methods include, for example, camera parameter adjustment methods, image processing methods and/or stereo calibration methods, etc. The camera parameter adjustment methods include, for example, exposure time adjustment, aperture adjustment and/or white balance adjustment, etc. The image processing methods includes, for example, contrast adjustment, brightness adjustment, color saturation adjustment, hue adjustment and/or image histogram equalization, etc. The stereo calibration methods, for example, includes image distortion calibration and/or stereo matching, etc.

In addition, in another embodiment, when the feedback unit 170 has provided at least one successfully recognized sample GD to the storage unit 180 for storage, the frame environment setting unit 120 could set the frame environment parameter PM according to the successfully recognized sample GD, thereby allowing the frame change detection unit 130 is easier to detect the interaction indicator appearance area AR. Setting the frame environment parameter PM based on the successfully recognized sample GD could significantly reduce the exploration time and speed up the detection. After the frame environment parameter PM is set, the frame could be detected more easily.

Then, the frame change detection unit 130 uses the frame change detection method AG1i to detect the interaction indicator appearance area AR in the video VD. The interaction indicator appearance area AR is, for example, the area where the user's palm, fingers, and gestures may appear or the area where obstacles may appear within the driving distance. At this time, the frame change detection unit 130 detects the interaction indicator appearance area AR, but has not yet detected the interaction indicator IX (such as the gesture ratio “5” or the obstacle x on the road).

The frame change detection method AG1i may include a fixed area method, a Background Subtraction method, a depth filtering method, a Temporal Differencing method, an image histogram difference method or an Optical Flow method, etc. These frame change detection methods AG1i have the opportunity to detect interaction indicator appearance area AR. In the present disclosure, different frame change detection methods AG1i could be used in different times. If there is a frame in the video VD that could be detected the interaction indicator appearance area AR using a certain frame change detection method AG1i, it could be included in the successfully recognized sample GD.

Then, the partial enhancement unit 140 performs partial enhancement on the interaction indicator appearance area AR, such as increasing the contrast, increasing the brightness, increasing the resolution, etc., to increase the probability of subsequently recognizing the interaction indicator IX. In some embodiments, the partial enhancement unit 140 may not be used.

Then, after obtaining the interaction indicator appearance area AR, the recognition unit 150 could use the recognition method AG2j to recognize the interaction indicator appearance area AR. In one embodiment, if the successfully recognized sample GD has been stored, the interaction indicator appearance area AR could be obtained according to the successfully recognized sample GD. The interaction indicator appearance area AR could have a certain degree of recognition confidence, and the recognition unit 150 is recognized within this interaction indicator appearance area AR, which is helpful for recognizing the interaction indicator IX.

The different recognition methods AG2j using in different times are, for example, detection video recognitions from different viewing angles and image recognitions from different image sensors. The image sensor could be a color camera, an infrared camera, a lidar, a radar, etc. The image recognition could include Local Binary Pattern (LBP), Oriented FAST and Rotated BRIEF (ORB), histogram of oriented gradients (HOG), speeded up robust features (SURF), scale-invariant feature transform (SIFT) or Convolutional neural network (CNN). These recognition methods AG2j have the opportunity to recognize the interaction indicator IX. In the present disclosure, different recognition methods AG2j are used in different times. If there is a frame in the video VD that could be successfully recognized the interaction indicator IX using a certain recognition method AG2j, it could be included in the successfully recognized sample GD.

When the interaction indicator IX is recognized and the recognition confidence CF of the interaction indicator IX is higher than the predetermined level, the weight setting unit 160 could increase the weight value WT of this recognition method AG2j. In other words, once it is found that a certain recognition method AG2j could effectively recognize the interaction indicator IX, the probability of using this recognition method AG2j in the subsequent adoption could be increased through weighting.

Then, when the interaction indicator IX is recognized and the recognition confidence CF of the interaction indicator IX is higher than the predetermined level, the feedback unit 170 could extract the characteristic parameters of the aforementioned frame environment parameter PM and/or the successfully recognized sample GD to the storage unit 180, and could also store the image recognition results of the retest method provided by the successfully recognized sample data unit 190. The position of interaction indicator features is fed back to the frame environment setting unit 120, the recognition unit 150, and the weight setting unit 160 from the storage unit 180. The output unit 200 outputs the interaction indicator. The interaction indicator provides interaction on the application side. For example, when the vehicle detects that the interaction indicator is an obstacle in the warning zone, the vehicle stops. Or, the screen could display corresponding interactive information in response to the gestures, the postures, or the facial features, etc. The following is a more detailed explanation of the extended usage of the successfully recognized sample data unit 190. One is that a successful recognition method could be used in subsequent interactive time. Another one is that a successfully recognized sample check method could be used to check the correctness of the interaction indicator during the idle time of operation when no interaction indicator appears continuously. For example, the same successfully recognized sample is used as the input image, and the interaction indicator is recognized through different recognition methods in steps S150, S160 and S200, and the recognition confidence and the interaction indicator are outputted. The recognition results of the same sample should be the same interaction indicator. If a different interaction indicator is recognized, the weight value of this recognition method should not be increased and should be kept low, and another different method may be used to check the interaction indicator.

The environmental detection unit 110, the frame environment setting unit 120, the frame change detection unit 130, the partial enhancement unit 140, the recognition unit 150, the weight setting unit 160, the feedback unit 170 and the output unit 200 are, for example, a circuit, a circuit board, a storage device storing program codes or a chip. The chip is, for example, a central processing unit (CPU), a programmable general-purpose or special-purpose microcontroller unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

The storage unit 180 and/or the success sample data unit 190 is, for example, any type of fixed or removable random-access memory (RAM), a read-only memory (ROM), a flash memory, a hard disk drive (HDD), a solid-state drive (SSD), a similar component, or a combination thereof, used to store multiple modules or various applications that could be executed by the processor. The storage unit 180 could be used for data comparison within continuous time, and could also be used to store temporary files of characteristic data in a small number of frames, such as using volatile memory. In addition to providing data comparison, the successfully recognized sample data unit 190 could also be used as an image database to re-test the recognition confidence of the interaction indicator on different recognition methods or to verify the recognition confidence of the recognition method on different interaction indicators. The successfully recognized sample data unit 190 may, for example, use non-volatile memory to leave a record after the system is shut down.

According to the above description, when the recognition system 100 for the interaction indicator in the video VD and the recognition method disclosed in the present disclosure are applied to various scenarios, the better frame environment parameter PM could be adaptively used to adjust the frame environment, and the interaction indicator appearance area AR could be provided to speed up the detection. In addition, when applied to various scenarios, the better recognition method AG2j could be adaptively used to quickly recognize the interaction indicator IX.

The following describes the application of the recognition method for the interaction indicator IX in the video VD disclosed in this disclosure for various scenarios.

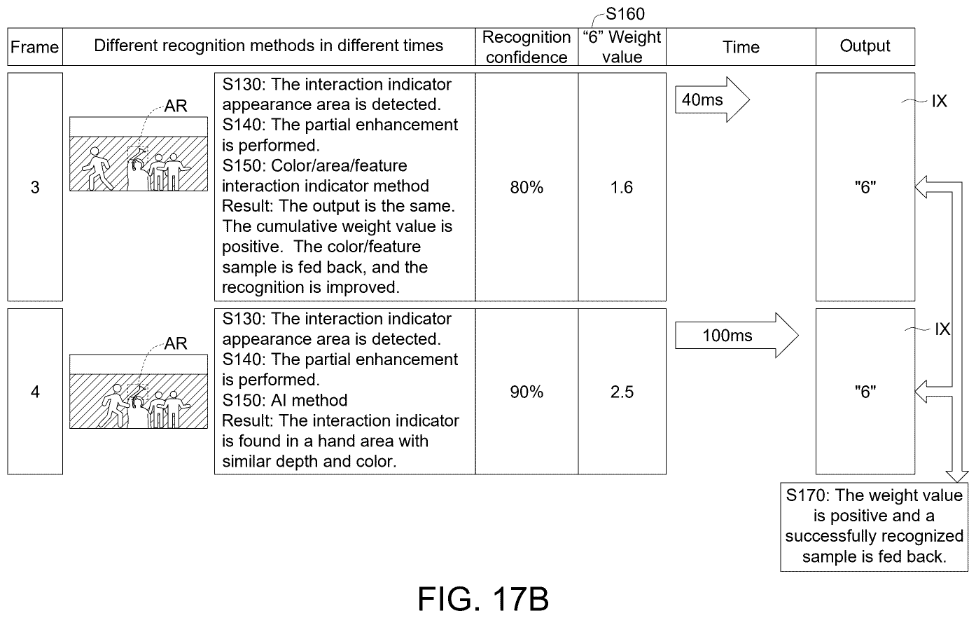

Please refer to FIGS. 16A to 16B, which illustrate an application example of the recognition method for the interaction indicator IX of the present disclosure. In the application example in FIGS. 16A to 16B, the user is in a scene with complex ambient light or color and is easily disturbed by the light or color. The interaction indicator to be recognized is the gesture “6”, but it is not easy to find the hand.

In the recognition process for the first frame, for example, an AI method is selected as the recognition method AG2j in the step S150. However, due to the interference of ambient light or color, for example, it took 100 ms but no hand joint nodes and the interaction indicator IX of “6” were recognized successfully. The recognition confidence CF of the recognition method AG2j (AI method) used in the first frame is 0%, and the weight value is 0.

In the recognition process for the second frame, in the step S150, for example, a depth recognition method is selected as the recognition method AG2j. At this time, for example, it took 30 ms to find the nearest hand and the interaction indicator IX of “6”. The recognition confidence CF of the recognition method AG2j (depth recognition method) used in the second frame is 80%, and the weight value is 0.8. The frame environment parameter PM used in the second frame and the detected interaction indicator appearance area AR could be added to the successfully recognized sample GD.

In the recognition process for the third frame, since there is already a successfully recognized sample GD, the interaction indicator appearance area AR of the successfully recognized sample GD could be used in the step S130. The partial enhancement is performed on this interaction indicator appearance area AR in the step S140. Then, in the step S150, a color/area/feature interaction indicator method is used as the recognition method AG2j. At this time, for example, it took 40 ms to find the interaction indicator IX with matching color/area/features in the closest hand area. The recognition confidence CF of the recognition method AG2j (color/area/feature interaction indicator method) used in the third frame is 80%, and the interaction indicator is the same as the interaction indicator of the previous frame, so the weight value is added to 0.8+0.8. The frame environment parameter PM used in the third frame and the detected interaction indicator appearance area AR could be added to the successfully recognized sample GD.

In the recognition process of the fourth frame, since there is already a successfully recognized sample GD, the interaction indicator appearance area AR of the successfully recognized sample GD could be used in the step S130. In the step S140, the interaction indicator appearance area AR is partially enhanced. Then, in the step S150, the AI method is selected as the recognition method AG2j. At this time, for example, it took 100 ms to find the interaction indicator IX in the hand area with similar depth and color. The recognition confidence CF of the recognition method AG2j (AI method) used in the fourth frame is 90%, and the interaction indicator is the same as that of the previous frame, so the weight value is 0.8+0.8+0.9. The frame environment parameter PM used in the fourth frame and the detected interaction indicator appearance area AR could be added to the successfully recognized sample GD.

In the embodiment of FIGS. 16A to 16B, under the four frames, the recognition confidence is successfully increased from 0% to 90%, and the recognition time required for the four frames is reduced from 400 ms to 270 (100+30+40+100) ms. According to the embodiment in FIGS. 16A to 16B, in a scene with complex ambient light or color, the recognition method for the interaction indicator disclosed in this disclosure could effectively improve the recognition rate and increase the calculation speed.

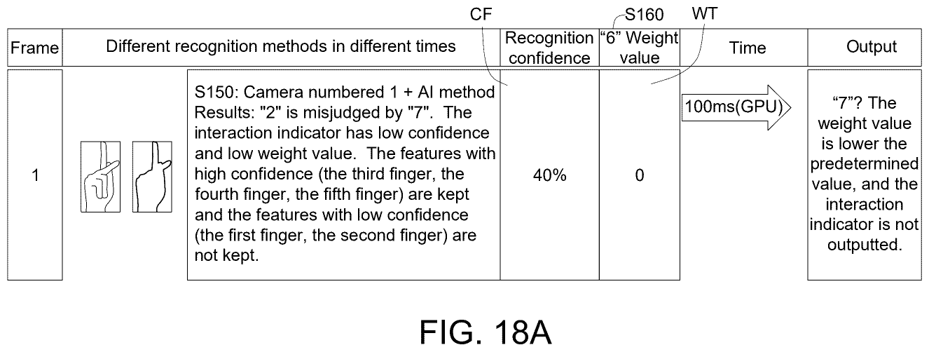

Please refer to FIGS. 17A to 17B, which illustrates another application example of the recognition method for the interaction indicator IX disclosed in the present disclosure. In the application example of FIGS. 17A to 17B, the user is in a multi-person interference scene, and it is not easy to find the correct user. The interaction indicator to be recognized is the gesture “6”.

During the recognition process for the first frame, for example, the AI method is selected as the recognition method AG2j in the step S150. However, due to the interference of many people, for example, it took 100 ms but no hand joint nodes and the interaction indicator IX of “6” were found. The recognition confidence CF of the recognition method AG2j (AI method) used in the first frame is 0%, and the weight value is 0.

In the recognition process of the second frame, for example, the depth recognition method is selected as the recognition method AG2j in the step S150. At this time, for example, it takes 30 ms to find the nearest hand and the interaction indicator IX of “6”. The wrong user is filtered out. Since the recognition of the previous frame failed, there is no accumulated weight value. The recognition confidence CF of the recognition method AG2j (depth interaction indicator method) used in the second frame is 80%, and a weight value is 0.8. The frame environment parameter PM and the detected interaction indicator appearance area AR used in the second frame could be added to the successfully recognized sample GD, which can be the depth profile.

In the recognition process of the third frame, since there is already a successfully recognized sample GD, the interaction indicator appearance area AR of the successfully recognized sample GD could be used in the step S130. In step S140, the interaction indicator appearance area AR is partially enhanced. Then, in the step S150, the color/area/feature interaction indicator method is selected as the recognition method AG2j. At this time, for example, it took 40 ms to find the interaction indicator IX with matching color/area/features in the hand area. The recognition method AG2j (color/area/feature interaction indicator method) used in the third frame has a recognition confidence CF of 80% and the interaction indicator is the same as the interaction indicator of the previous frame, so the weight value is 0.8+0.8. The frame environment parameter PM used in the third frame and the detected interaction indicator appearance area AR could be added to the successfully recognized sample GD.

In the recognition process of the fourth frame, since there is already a successfully recognized sample GD, the interaction indicator appearance area AR of the successfully recognized sample GD could be used in the step S130. In step S140, the interaction indicator appearance area AR is partially enhanced. Then, in the step S150, the AI method is selected as the recognition method AG2j. At this time, for example, it took 100 ms to find the interaction indicator IX in the hand area with similar depth and color. The recognition confidence CF of the recognition method AG2j (AI method) used in the fourth frame is 90%, and the interaction indicator is the same as the interaction indicator of the previous frame, so the weight value is 0.8+0.8+0.9. The frame environment parameter PM used in the fourth frame and the detected interaction indicator appearance area AR could be added to the successfully recognized sample GD.

In the embodiment of FIGS. 17A to 17B, under four frames, the recognition confidence is successfully increased from 0% to 90%, and the recognition time required for four frames is reduced from 400 ms to 270 (100+30+40+100) ms. According to the embodiment in FIGS. 17A to 17B, in a scenario where multiple people interfere and the correct user cannot be found, the recognition method for the interaction indicator disclosed in this disclosure could effectively improve the recognition rate and increase the computing speed.

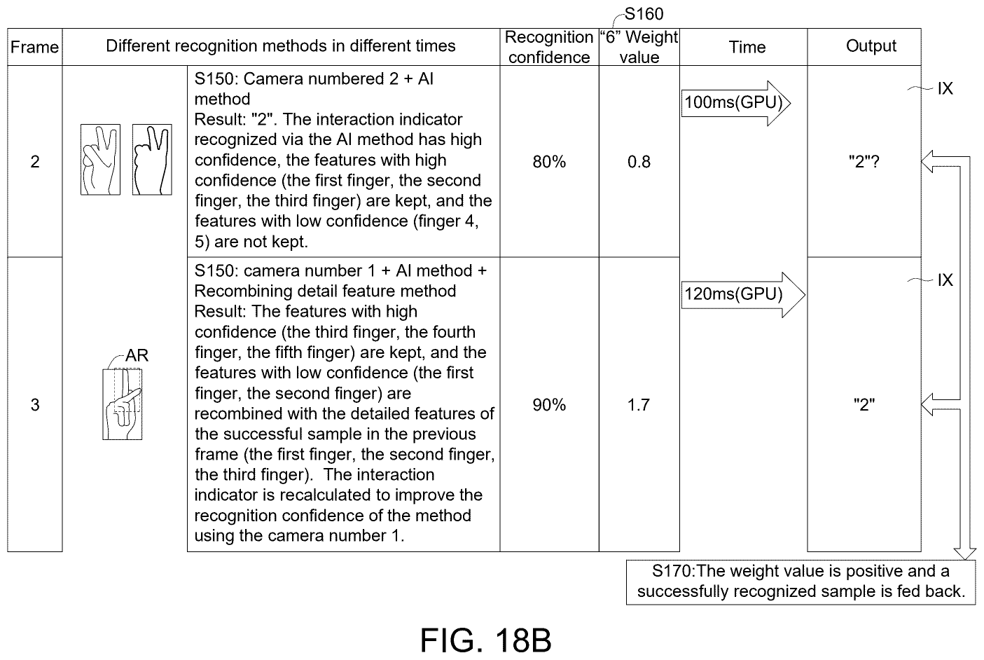

Please refer to FIGS. 18A to 18B, which illustrates another application example of the recognition method for the interaction indicator IX according to the present disclosure. In the application example in FIGS. 18A to 18B, the detail features of hand are insufficient, so it difficult to recognize the interaction indicator IX. For example, the interaction indicator is recognized as the gesture “2”, but it may be misjudged as the gesture “7”.

In the recognition process of the first frame, for example, the camera numbered “1” is used in the step S150, and the AI method is used as the recognition method AG2j. However, the joint nodes of first finger and the second finger is obscured, it took 100 ms but the “2” gesture was misjudged as a “7” gesture. The recognition confidence of the third finger, the fourth finger and the fifth finger is high, and the recognition confidence of the first finger and the second finger is low. The recognition confidence CF of the recognition method AG2j (AI method) used in the first frame is 40% is lower than 80%, so the weight value is 0, and the gesture “7” is not output.

In the recognition process for the second frame, in the step S150, for example, the camera numbered “2” is used and the AI method is used as the recognition method AG2j. At this time, for example, it took 30 ms to recognize the interaction indicator IX of “2”. The recognition confidence of the first finger, the second finger, and the third finger is high, and the recognition confidence of the fourth finger and the fifth finger is low. The recognition confidence CF of the recognition method AG2j (AI method) used in the second frame is 80%, and the weight value is 0.8. The frame environment parameter PM used in the second frame and the detected interaction indicator appearance area AR could be added to the successfully recognized sample GD.

In the recognition process for the third frame, for example, the camera numbered “1” is used in the step S150, and the AI method is used as the recognition method AG2j. The third finger, the fourth finger, and the fifth finger with higher recognition confidence are retained, and the first finger and the second finger with lower recognition confidence are recombined with the detailed features (the first finger, the second finger, and the third finger) of the successfully recognized sample GD of the previous frame for recalculation. It took 100 ms on recognition method AG2j and additionally took 20 ms on recombining detailed features with high confidence. Therefore, the recognition confidence of the camera numbered “1” is improved and the recognition confidence is successfully increased from 40% to 90%. According to the embodiment in FIGS. 18A to 18B, in the scenarios where the detail features of the hand are insufficient, the recognition method for the interaction indicator disclosed in this disclosure could effectively improve the recognition efficiency.

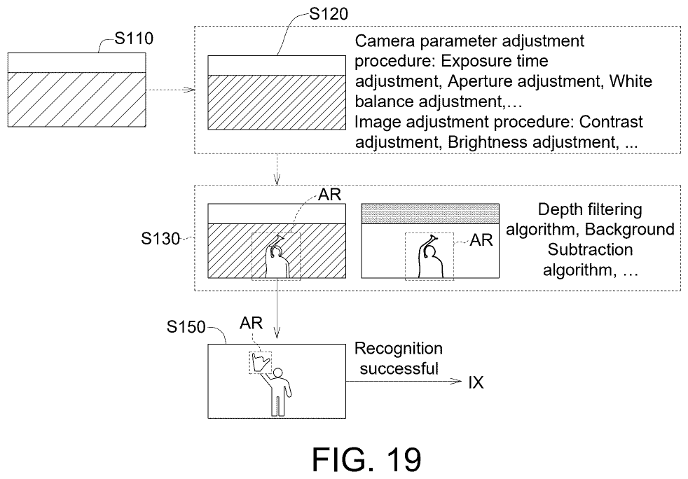

Please refer to FIG. 19, which illustrates another application example of the recognition method for the interaction indicator IX according to the present disclosure. In the application example in FIG. 19, it is a known static background and the user is at a fixed position. The recognition is successful after adjusting the frame environment parameter PM.

In the step S110, the environmental detection unit 110 detects changes in light or color of the video VD.

Next, in the step S120, the frame environment setting unit 120 sets some camera parameter adjustment procedures, such as an exposure time adjustment, an aperture adjustment, a white balance adjustment, a contrast adjustment and a brightness adjustment.

Then, in the step S130, the frame change detection unit 130 uses, for example, a depth filtering method and a background subtraction method as the frame change detection method AG1i to detect the interaction indicator appearance area AR in the video VD. After the above steps, the frame change detection unit 130 could successfully detect the interaction indicator appearance area AR.

Then, the process proceeds to the step S150. The recognition method AG2j is used to recognize the interaction indicator IX.

In the embodiment in FIG. 19, the camera parameter adjustment methods and the image processing methods are used to adjust the frame appropriately, so that the interaction indicator appearance area AR could be successfully detected and the interaction indicator IX could be correctly recognized.

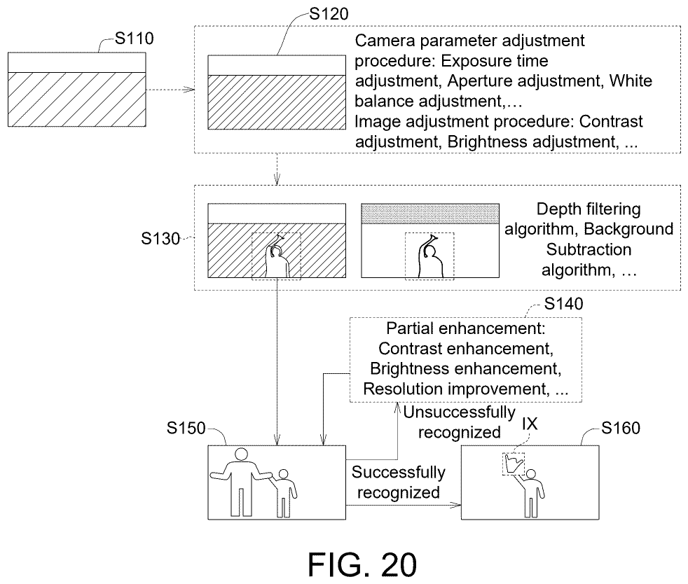

Please refer to FIG. 20, which illustrates another application example of the recognition method for the interaction indicator IX according to the present disclosure. In the application example in FIG. 20, a static background is known and the user is not at a fixed position. After the frame environment parameter PM is adjusted, it still needs to be detected by different detection methods. In step S110, the environmental detection unit 110 detects a change in light or color in the video VD.

Next, in the step S120, the frame environment setting unit 120 sets a camera parameter adjustment procedure, such as an exposure time adjustment, an aperture adjustment, a white balance adjustment, a contrast adjustment and a brightness adjustment.

Then, in the step S130, the frame change detection unit 130 uses the depth filtering method and the background subtraction method as the frame change detection method AG1i to detect the interaction indicator appearance area AR in the video VD.

Next, the process proceeds to the step S150 to recognize the interaction indicator IX. In the first few frames, the interaction indicator IX cannot be successfully recognized. The process could go back to the step S140 and the partial enhancement unit 140 could perform operations such as a contrast enhancement, a brightness enhancement, and a resolution improvement on the interaction indicator appearance area AR. After performing the partial enhancement, the interaction indicator IX could be recognized using the recognition method AG2j in the step S150.

Afterwards, in the step S160, when the interaction indicator IX is recognized and the recognition confidence CF of the interaction indicator IX is higher than the predetermined level, the weight setting unit 160 could increase the weight value of the recognition method AG2j. Moreover, in each subsequent frame, the tracking and partial enhancement of the interaction indicator appearance area AR are continued in order to obtain correct recognition results.

In the embodiment of FIG. 20, in addition to using the camera parameter adjustment method and the video adjustment method to adjust the frame, the partial enhancement technology could be further used to enhance the visibility of the interaction indicator appearance area AR, making the interaction indicator IX recognizable.

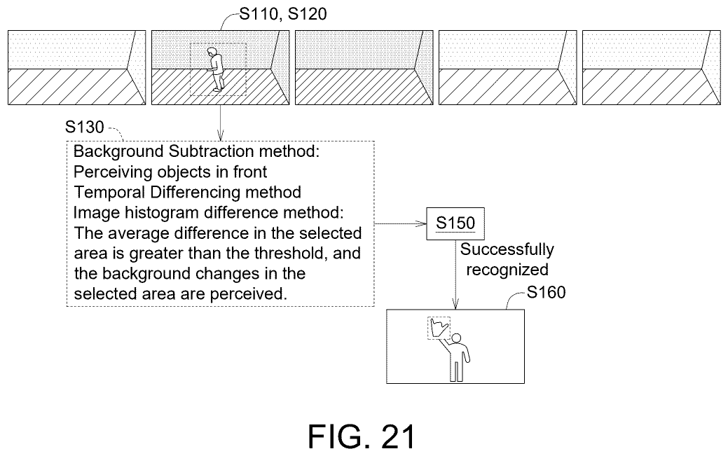

Please refer to FIG. 21, which illustrates another application example of the recognition method for the interaction indicator IX according to the present disclosure. In the application example in FIG. 21, the environment (such as a sailing environment, where the light source may change brightness and/or direction within a few minutes) is unknown or dynamic and the user is at a fixed position. After processing by this technology, the recognition is successful.

In the steps S110 and S120, after the environmental detection unit 110 detects that the video VD has changed in light or color, the frame environment setting unit 120 sets the frame environment parameter PM.

Then, in the step S130, the frame change detection unit 130 selects, for example, the Background Subtraction method, the Frame Differencing method or the histogram difference method as the frame change detection method AG1i to detect the interaction indicator appearance area AR of the image video VD. The Background Subtraction method could be used to perceive the object in front; the image histogram difference method could be used to perceive the background changes in the selected area when the mean difference in the selected area is greater than the threshold; the Temporal Differencing method could use temporally continuous videos to do one-to-one Pixel subtraction, and this method is adaptable to the changes in the environment.

Then, the process proceeds to the step S150 and the recognition method AG2j is used to recognize the interaction indicator IX.

Next, in the step S160, when the interaction indicator IX is recognized and the recognition confidence CF of the interaction indicator IX is higher than the predetermined level, the weight setting unit 160 increases the weight value of the recognition method AG2j.

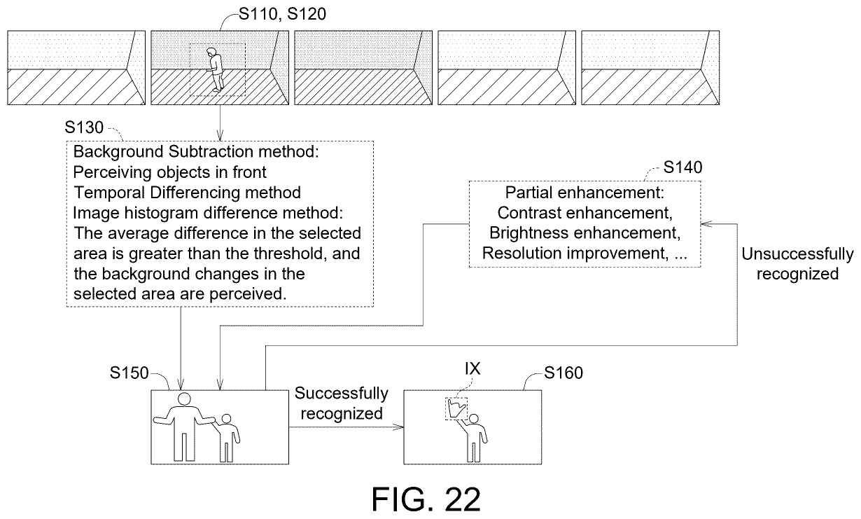

Please refer to FIG. 22, which illustrates another application example of the recognition method for the interaction indicator IX according to the present disclosure. In the application example of FIG. 22, the environment is unknown or dynamic and the user is at a non-fixed position, through the frame environment parameter PM after adjustment, features still have to be found by different methods.

In steps S110 and S120, after the environmental detection unit 110 detects that the video VD has changed in light or color, the frame environment setting unit 120 sets the frame environment parameter PM.

Then, in the step S130, the frame change detection unit 130 selects the Background Subtraction method, the Temporal Differencing method or the image histogram difference method as the frame change detection method AG1i to detect the interaction indicator appearance area AR in the video VD.

Then, the process proceeds to the step S150 to recognize the interaction indicator IX. In the first few frames, the interaction indicator IX cannot be successfully recognized. The process could return to the step S140 and use the partial enhancement unit 140 to perform on some actions, such as the contrast enhancement, the brightness enhancement, and the resolution improvement, on the interaction indicator appearance area AR. After the enhancement, the interaction indicator IX could be recognized using the recognition method AG2j in step S150.

Next, in the step S160, when the interaction indicator IX is recognized and the recognition confidence CF of the interaction indicator IX is higher than the predetermined level, the weight setting unit 160 could increase the weight value of the recognition method AG2j. And, in the subsequent frames, the process continues the tracking and partial enhancement for the interaction indicator appearance area AR in order to obtain correct recognition results.

In the embodiment of the FIG. 22, in addition to appropriately adjusting the frame using the frame environment parameter PM, the partial enhancement technology is also used to enhance the visibility of the interaction indicator appearance area AR, so that the interaction indicator IX could be recognized successfully.

According to the above embodiments, when the recognition system 100 and the recognition method for the interaction indicator of the present disclosure are applied to various scenarios, the better frame environment parameter PM could be adaptively used to adjust the environment of the frame, and the interaction indicator appearance area AR could be used to speed up the detection. In addition, when applied to various scenarios, the better recognition method AG2j could be adaptively used to quickly recognize the interaction indicator IX. When necessary, the partial enhancement technology could be used to enhance the interaction indicator appearance area AR, thereby the recognition rate and the recognition speed could be improved.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

According to one example embodiment, a recognition method for an interaction indicator is provided. The recognition method for the interaction indicator is used for recognizing the interaction indicator in a video. The recognition method for the interaction indicator includes: recognizing the interaction indicator via at least one recognition method, wherein the recognition method is not exactly the same at different times; and increasing a weight value of the recognition method, when the interaction indicator is recognized and a recognition confidence of the interaction indicator is higher than a predetermined level.

Based on the recognition method for the interaction indicator described in the previous embodiments, the recognition method outputs the interaction indicator and the recognition confidence, under a situation that the video contains continuous frames, if the recognition confidence of the interaction indicator is lower than the predetermined level, the weight value of the recognition method is not increased.

Based on the recognition method for the interaction indicator described in the previous embodiments, when the recognition confidence of the interaction indicator outputted by the recognition method is higher than the predetermined level, a successfully recognized sample is recorded, and the successfully recognized sample is used to reset the recognition method or the interaction indicator.

Based on the recognition method for the interaction indicator described in the previous embodiments, the recognition method for the interaction indicator further includes: detecting whether the video has changed in light or color; setting at least one frame environment parameter, if the video has changed in light or color, wherein when at least one successfully recognized sample has been stored, the frame environment parameter is set according to the at least one successfully recognized sample.

Based on the recognition method for the interaction indicator described in the previous embodiments, the recognition method for the interaction indicator further includes: detecting an interaction indicator appearance area in the video via a frame change detection method; and performing a partial enhancement on the interaction indicator appearance area.

Based on the recognition method for the interaction indicator described in the previous embodiments, if the recognition confidence of the interaction indicator is higher than the predetermined level, at least one frame environment parameter and a frame change detection method is used as a successfully recognized sample.

Based on the recognition method for the interaction indicator described in the previous embodiments, the interaction indicator is at least one facial feature, at least one gesture, at least one posture, or at least one object.

Based on the recognition method for the interaction indicator described in the previous embodiments, when the interaction indicator and a first detailed feature and a second detailed feature thereof are recognized via the recognition method, the recognition confidence of the first detailed feature is lower than the predetermined level, and the recognition confidence of the second detailed feature higher than the predetermined level, the second detailed feature is recorded as a successfully recognized sample; the second detailed feature as the successfully recognized sample is used to recombine into a third detailed feature.

Based on the recognition method for the interaction indicator described in the previous embodiments, during an idle time of operation, a successfully recognized sample checking method is used to check a correctness of the interaction indicator in a successfully recognized sample, and if different interaction indicators are recognized, the weight value of the recognition method is maintained.

Based on the recognition method for the interaction indicator described in the previous embodiments, the recognition method and a frame environment parameter are selected according to a weight calculation method.

According to one example embodiment, a recognition system for an interaction indicator is provided. The recognition system for the interaction indicator is used for recognizing the interaction indicator in a video. The recognition system for the interaction indicator includes a recognition unit, a weight setting unit, a weight setting unit and a storage unit. The recognition unit is used for recognizing the interaction indicator via a recognition method. The recognition method is not exactly the same at different times. The weight setting unit is used for increasing a weight value of the recognition method, when the interaction indicator is recognized and a recognition confidence of the interaction indicator is higher than a predetermined level. The storage unit is used for storing a recognition result, the weight value of the recognition method, the interaction indicator and the recognition confidence.

Based on the recognition system for the interaction indicator described in the previous embodiments, the recognition unit outputs the interaction indicator and the recognition confidence, under a situation that the video contains continuous frames, if the recognition confidence of the interaction indicator is lower than the predetermined level, the weight value of the recognition method is not increased.

Based on the recognition system for the interaction indicator described in the previous embodiments, when the recognition confidence of the interaction indicator outputted by the recognition unit is higher than the predetermined level, a successfully recognized sample is recorded, and the successfully recognized sample is used to reset the recognition method or the interaction indicator.

Based on the recognition system for the interaction indicator described in the previous embodiments, the recognition system for the interaction indicator further includes an environmental detection unit and a frame environment setting unit. The environmental detection unit is used for detecting whether the video has changed in light or color. The frame environment setting unit is used for setting at least one frame environment parameter, if the video has changed in light or color. When at least one successfully recognized sample has been stored, frame environment setting unit sets the frame environment parameter according to the at least one successfully recognized sample.

Based on the recognition system for the interaction indicator described in the previous embodiments, the recognition system for the interaction indicator further includes a frame change detection unit and a partial enhancement unit. The frame change detection unit is used for detecting an interaction indicator appearance area in the video via a frame change detection method, wherein when at least one successfully recognized sample has been stored, the interaction indicator appearance area is obtained according to the successfully recognized sample. The partial enhancement unit is used for performing a partial enhancement on the interaction indicator appearance area.

Based on the recognition system for the interaction indicator described in the previous embodiments, if the recognition confidence of the interaction indicator is higher than the predetermined level, at least one frame environment parameter and a frame change detection method is used as a successfully recognized sample.

Based on the recognition system for the interaction indicator described in the previous embodiments, the interaction indicator is at least one facial feature, at least one gesture, at least one posture, or at least one object.

Based on the recognition system for the interaction indicator described in the previous embodiments, when the interaction indicator and a first detailed feature and a second detailed feature thereof are recognized by the recognition unit, the recognition confidence of the first detailed feature is lower than the predetermined level, and the recognition confidence of the second detailed feature higher than the predetermined level, the second detailed feature is recorded as a successfully recognized sample; the second detailed feature as the successfully recognized sample is used to recombine into a third detailed feature.

Based on the recognition system for the interaction indicator described in the previous embodiments, during an idle time of operation, a successfully recognized sample checking method is used to check a correctness of the interaction indicator in a successfully recognized sample, and if different interaction indicators are recognized, the weight value of the recognition method is maintained.

Based on the recognition system for the interaction indicator described in the previous embodiments, the recognition method and a frame environment parameter are selected according to a weight calculation method.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A recognition method for an interaction indicator, used for recognizing the interaction indicator in a video, wherein the recognition method for the interaction indicator comprises:
recognizing the interaction indicator via at least one recognition method, wherein the recognition method is not exactly the same at different times; and
increasing a weight value of the recognition method, when the interaction indicator is recognized and a recognition confidence of the interaction indicator is higher than a predetermined level.

2. The recognition method for the interaction indicator according to claim 1, wherein the recognition method outputs the interaction indicator and the recognition confidence, under a situation that the video contains continuous frames, if the recognition confidence of the interaction indicator is lower than the predetermined level, the weight value of the recognition method is not increased.

3. The recognition method for the interaction indicator according to claim 1, wherein when the recognition confidence of the interaction indicator outputted by the recognition method is higher than the predetermined level, a successfully recognized sample is recorded, and the successfully recognized sample is used to retest the recognition method or the interaction indicator.

4. The recognition method for the interaction indicator according to claim 1, further comprises:
detecting whether the video has changed in light or color;
setting at least one frame environment parameter, if the video has changed in light or color, wherein when at least one successfully recognized sample has been stored, the frame environment parameter is set according to the at least one successfully recognized sample.

5. The recognition method for the interaction indicator according to claim 1, further comprises:
detecting an interaction indicator appearance area in the video via a frame change detection method; and
performing a partial enhancement on the interaction indicator appearance area.

6. The recognition method for the interaction indicator according to claim 1, wherein if the recognition confidence of the interaction indicator is higher than the predetermined level, at least one frame environment parameter and a frame change detection method is used as a successfully recognized sample.

7. The recognition method for the interaction indicator according to claim 1, wherein the interaction indicator is at least one facial feature, at least one gesture, at least one posture, or at least one object.

8. The recognition method for the interaction indicator according to claim 1, wherein when the interaction indicator and a first detailed feature and a second detailed feature thereof are recognized via the recognition method, the recognition confidence of the first detailed feature is lower than the predetermined level, and the recognition confidence of the second detailed feature higher than the predetermined level, the second detailed feature is recorded as a successfully recognized sample; the second detailed feature as the successfully recognized sample is used to recombine into a third detailed feature.

9. The recognition method for the interaction indicator according to claim 1, wherein during an idle time of operation, a successfully recognized sample checking method is used to check a correctness of the interaction indicator in a successfully recognized sample, and if different interaction indicators are recognized, the weight value of the recognition method is maintained.

10. The recognition method for the interaction indicator according to claim 1, wherein the recognition method and a frame environment parameter are selected according to a weight calculation method.

11. A recognition system for an interaction indicator, used for recognizing the interaction indicator in a video, wherein the recognition system for the interaction indicator comprises:
a recognition unit, used for recognizing the interaction indicator via a recognition method, wherein the recognition method is not exactly the same at different times;
a weight setting unit, used for increasing a weight value of the recognition method, when the interaction indicator is recognized and a recognition confidence of the interaction indicator is higher than a predetermined level; and
a storage unit, used for storing a recognition result, the weight value of the recognition method, the interaction indicator and the recognition confidence.

12. The recognition system for the interaction indicator according to claim 11, wherein the recognition unit outputs the interaction indicator and the recognition confidence, under a situation that the video contains continuous frames, if the recognition confidence of the interaction indicator is lower than the predetermined level, the weight value of the recognition method is not increased.

13. The recognition system for the interaction indicator according to claim 11, wherein when the recognition confidence of the interaction indicator outputted by the recognition unit is higher than the predetermined level, a successfully recognized sample is recorded, and the successfully recognized sample is used to retest the recognition method or the interaction indicator.

14. The recognition system for the interaction indicator according to claim 11, further comprises:
an environmental detection unit, used for detecting whether the video has changed in light or color; and
a frame environment setting unit, used for setting at least one frame environment parameter, if the video has changed in light or color, wherein when at least one successfully recognized sample has been stored, the frame environment setting unit sets the frame environment parameter according to the at least one successfully recognized sample.

15. The recognition system for the interaction indicator according to claim 11, further comprises:
a frame change detection unit, used for detecting an interaction indicator appearance area in the video via a frame change detection method, wherein when at least one successfully recognized sample has been stored, the interaction indicator appearance area is obtained according to the successfully recognized sample; and
a partial enhancement unit, used for performing a partial enhancement on the interaction indicator appearance area.

16. The recognition system for the interaction indicator according to claim 11, wherein if the recognition confidence of the interaction indicator is higher than the predetermined level, at least one frame environment parameter and a frame change detection method is used as a successfully recognized sample.

17. The recognition system for the interaction indicator according to claim 11, wherein the interaction indicator is at least one facial feature, at least one gesture, at least one posture, or at least one object.

18. The recognition system for the interaction indicator according to claim 11, wherein when the interaction indicator and a first detailed feature and a second detailed feature thereof are recognized by the recognition unit, the recognition confidence of the first detailed feature is lower than the predetermined level, and the recognition confidence of the second detailed feature higher than the predetermined level, the second detailed feature is recorded as a successfully recognized sample; the second detailed feature as the successfully recognized sample is used to recombine into a third detailed feature.

19. The recognition system for the interaction indicator according to claim 11, wherein during an idle time of operation, a successfully recognized sample checking method is used to check a correctness of the interaction indicator in a successfully recognized sample, and if different interaction indicators are recognized, the weight value of the recognition method is maintained.

20. The recognition system for the interaction indicator according to claim 11, wherein the recognition method and a frame environment parameter are selected according to a weight calculation method.
